(19) United States
(12) Patent Application Publication
(10) Pub. No.: US 2013/0089847 A1
(43) Pub. Date: Apr. 11, 2013

(54) SYSTEMS AND METHODS FOR MONITORING eLEARNING SYSTEM DATA AND GENERATING RECOMMENDATIONS

(71) Applicants: John Allen Baker, Waterloo (CA); Nathan James Hoel, Kitchener (CA); Kenneth James Chapman, Kitchener (CA)

(72) Inventors: John Allen Baker, Waterloo (CA); Nathan James Hoel, Kitchener (CA); Kenneth James Chapman, Kitchener (CA)

(21) Appl. No.: 13/271,082

(22) Filed: Oct. 11, 2011

(51) Int. Cl. G09B 5/00

(52) U.S. Cl. 434/322

(57) ABSTRACT

According to one aspect, an online learning system comprising a processor adapted to provide a monitoring module, a recommendation module and a communication module. The monitoring module is operable to monitor system data about one or more components of the online learning environment wherein the system data is indicative of behavior of one or more users of the learning environment. The recommendation module is operable to determine whether the system data for a given component meets one or more defined thresholds, each threshold being indicative of undesirable behavior associated with that component, and if one of the given thresholds is met, determine at least one remedial action associated with that threshold which may be employed to address the undesirable behavior. The communication module is operable to communicate information about the at least one remedial action to at least one user.

### TECHNICAL FIELD

The embodiments herein relate to monitoring eLearning system data, and in particular to systems and methods for monitoring system data in an eLearning environment and generating recommendations therefor.

### INTRODUCTION

Electronic learning (also called e-Learning or eLearning) generally refers to education or learning where users engage in education related activities using computers and other computer devices. For example, users may enroll or participate in a course or program of study offered by an educational institution (e.g. a college, university or grade school) through a web interface that is accessible over the Internet. Users may receive assignments electronically, participate in group work and projects by collaborating online, and be graded based on assignments and examinations that are submitted, for example using an electronic drop box.

Electronic learning is not limited to use by educational institutions, however, and may also be used in government or in corporate environments. For example, employees at a regional branch office of a particular company may use electronic learning to participate in a training course offered by another office without ever physically leaving their branch office.

While eLearning offers many advantages, it also provides some challenges to instructors in comparison to a traditional learning environment. For example, an instructor in a traditional learning environment can generally gauge the interest level, performance, and other characteristics of an individual learner or a class as a whole based on the direct observations of physical participation in the classroom environment. However, in an eLearning environment, it may be more challenging to get feedback information since the learners and the instructors often do not meet in person, and generally have much more limited physical interactions.

To encourage effective eLearning, various learning tools may be available to the various users of an eLearning system. For example, instructors may have access to learning tools such as quiz development tools, assessment tools, discussion forums, class performance monitoring tools, guided instructional design tools, learning heuristics and so on. Similarly, learners may have access to various learning tools such as quizzes, learning materials, performance tracking and so on. However, some of these learning tools might not be efficiently utilized. For example, some users (e.g. an instructor) may not be aware of the existence of a particular learning tool. Similarly, a learner, for a variety of reasons, may not be aware of or have engaged with a particular learning tool.

### SUMMARY

According some embodiments, there is provided a computer-implemented eLearning method including the steps of monitoring system data about one or more components of an online learning environment, the system data being indicative of behavior of one or more users of the learning environment. The method includes determining whether the system data for a given component meets one or more defined thresholds, each threshold being indicative of undesirable behavior associated with that component. If one of the given thresholds is met, the method includes determining at least one remedial action associated with that threshold which may be employed to address the undesirable behavior, and communicating information about the at least one remedial action to at least one user.

In some embodiments, when more than one defined thresholds are met, the method further includes the steps of determining a priority value indicative of an importance of addressing the undesirable behavior associated with those thresholds, selecting at least one of those thresholds to address based on the priority value and determining the remedial action associated with the selected threshold.

In some embodiments, the remedial actions and priority values associated with each threshold are determined based upon a predefined condition-action matrix.

In some embodiments, the at least one remedial action that may be employed when the threshold is met is determined based upon instructional design.

In some embodiments, the at least one remedial action that may be employed when the threshold is met is determined based upon at least one predefined workflow.

In some embodiments, the system data about one or more components includes utilization data for those components.

In some embodiments, the utilization data includes user-account information indicative of one or more users that have or have not utilized one of the components a particular period of time.

In some embodiments, the one or more components includes one or more learning tools, and the system data includes tool data indicative of utilization of one or more aspects of those tools.

In some embodiments, one of the remedial actions includes sending a targeted notification message to the one or more users that have not used one of the components.

In some embodiments, one of the remedial actions includes sending a plurality of notification messages to a plurality of users associated with a system component.

According to yet other embodiments, there is provided an online learning system including a processor adapted to provide a monitoring module, a recommendation module and a communication module. The monitoring module is operable to monitor system data about one or more components of the online learning environment wherein the system data is indicative of behavior of one or more users of the learning environment. The recommendation module is operable to determine whether the system data for a given component meets one or more defined thresholds, each threshold being indicative of undesirable behavior associated with that component, and if one of the given thresholds is met, determine at least one remedial action associated with that threshold which may be employed to address the undesirable behavior. The communication module is operable to communicate information about the at least one remedial action to at least one user.

In some embodiments, when more than one defined thresholds are met the recommendation module is further operable to determine a priority value indicative of an importance of addressing the undesirable behavior associated with those thresholds, select at least one of those thresholds to address based on the priority value, and determine the remedial action associated with the selected threshold.

### BRIEF DESCRIPTION OF THE DRAWINGS

The drawings included herewith are for illustrating various examples of systems, methods and apparatus of the present specification and are not intended to limit the scope of what is taught in any way. In the drawings:

FIG. 1 is a schematic diagram of a eLearning system according to some embodiments;

FIG. 2 is a schematic diagram of some components that may be implemented on a server shown in FIG. 1 according to some embodiments;

FIG. 3 is a table showing exemplary learning tools that may be provided by the system of FIG. 1;

FIG. 4 is a table showing exemplary thresholds that are associated with the learning tools shown in FIG. 3;

FIG. 5 is a table showing exemplary remedial actions that are associated with the thresholds shown in FIG. 4;

FIG. 6 is a table showing priority values that are associated with the thresholds and remedial actions shown in FIG. 4;

FIG. 7 is a table showing information messages that are associated with the remedial actions shown in FIG. 5; and

FIG. 8 is flowchart showing steps of a computer implemented learning method according to some embodiments.

### DETAILED DESCRIPTION OF SOME EMBODIMENTS

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

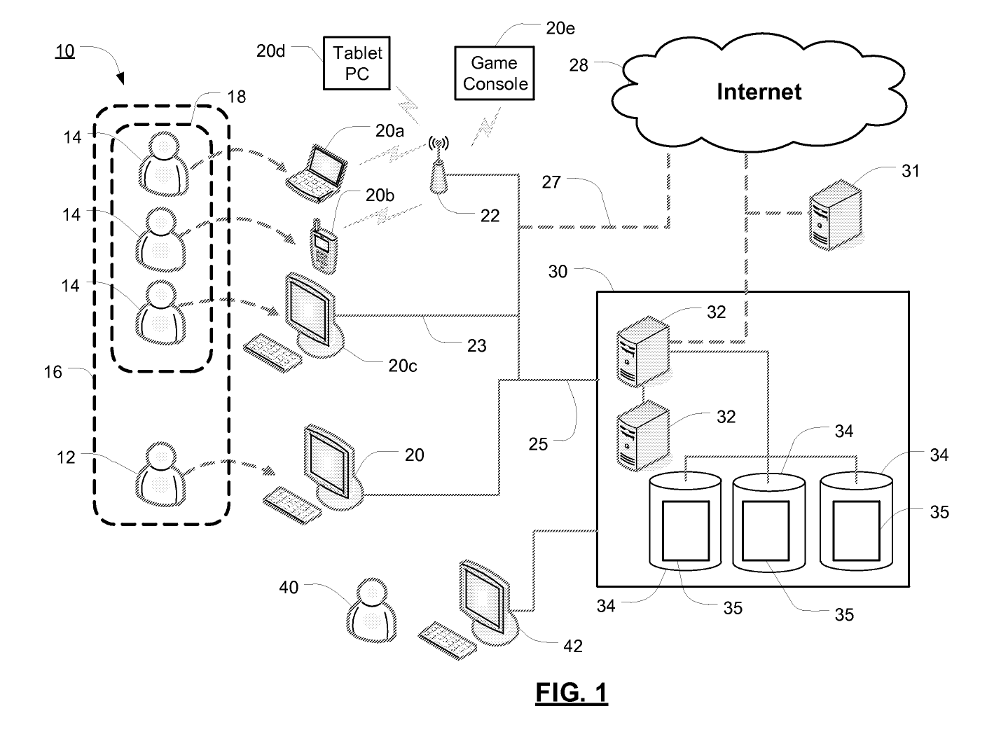

Referring now to FIG. 1, illustrated therein is an educational system 1 or eLearning system for providing electronic learning according to some embodiments.

Using the system 10, one or more users 12, 14 may communicate with an educational service provider 30 to participate in, create, and consume electronic learning services, including educational courses. In some cases, the educational service provider 30 may be part of (or associated with) a traditional “bricks and mortar” educational institution (e.g. a grade school, university or college), another entity that provides educational services (e.g. an online university, a company that specializes in offering training courses, an organization that has a training department, etc.), or may be an independent service provider (e.g. for providing individual electronic learning).

It should be understood that a course is not limited to formal courses offered by formal educational institutions. The course may include any form of learning instruction offered by an entity of any type. For example, the course may be a training seminar at a company for a group of employees or a professional certification program (e.g. PMP, CMA, etc.) with a number of intended participants.

In some embodiments, one or more educational groups can be defined that includes one or more of the users 12, 14. For example, as shown in FIG. 1, the users 12, 14 may be grouped together in an educational group 16 representative of a particular course (e.g. History 101, French 254), with a first user 12 or “instructor” being responsible for organizing and/or teaching the course (e.g. developing lectures, preparing assignments, creating educational content etc.), while the other users 14 or “learners” are consumers of the course content (e.g. users 14 are enrolled in the course).

In some examples, the users 12, 14 may be associated with more than one educational group (e.g. the users 14 may be enrolled in more than one course, a user may be enrolled in one course and be responsible for teaching another course, a user may be responsible for teaching a plurality of courses, and so on).

In some cases, educational sub-groups may also be formed. For example, the users 14 are shown as part of educational sub-group 18. The sub-group 18 may be formed in relation to a particular project or assignment (e.g. sub-group 18 may be a lab group) or based on other criteria. In some embodiments, due to the nature of the electronic learning, the users 14 in a particular sub-group 18 need not physically meet, but may collaborate together using various tools provided by the educational service provider 30.

In some embodiments, other groups 16 and sub-groups 18 could include users 14 that share common interests (e.g. interests in a particular sport), that participate in common activities (e.g. users that are members of a choir or a club), and/or have similar attributes (e.g. users that are male, users under twenty-one years of age, etc.).

Communication between the users 12, 14 and the educational service provider 30 can occur either directly or indirectly using any one or more suitable computing devices. For example, the user 12 may use a computing device 20 having one or more client processors such as a desktop computer that has at least one input device (e.g. a keyboard and a mouse) and at least one output device (e.g. a display screen and speakers).

The computing device 20 can generally be any suitable device for facilitating communication between the users 12, 14 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20c, a tablet computer 20d, or a game console 20e over a wired connection 23.

The computing devices 20 may be connected to the service provider 30 via any suitable communications channel. For example, the computing devices 20 may communicate to the educational service provider 30 over a local area network (LAN) or intranet, or using an external network (e.g. by using a browser on the computing device 20 to browse to one or more web pages (electronic files) presented over the Internet 28 over a data connection 27).

In some examples, one or more of the users 12, 14 may be required to authenticate their identities in order to communicate with the educational service provider 30. For example, the users 12, 14 may be required to input a login name and/or a password or otherwise identify themselves to gain access to the system 10.

In some examples, one or more users (e.g. “guest” users) may be able to access the system without authentication. Such guest users may be provided with limited access, such as the ability to review one or more components of the course to decide whether they would like to participate in the course but without the ability to post comments or upload electronic files.

In some embodiments, the wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g. a course page).

The educational service provider 30 generally includes a number of functional components for facilitating the provision of electronic learning services. For example, the educational service provider 30 generally includes one or more processing devices such as servers 32, each having one or more processors. The processors on the servers 32 will be referred to generally as “remote processors” so as to distinguish from client processors found in computing devices (20, 20a-20e). The servers 32 are configured to send information (e.g. electronic files such as web pages) to be displayed on one or more computing devices 20 in association with the electronic learning system 10 (e.g. course information). In some embodiments, a server 32 may be a computing device 20 (e.g. a laptop or personal computer).

The educational service provider 30 also generally includes one or more data storage devices 34 (e.g. memory, etc.) that are in communication with the servers 32, and could include a relational database (such as a SQL database), or other suitable data storage devices. The data storage devices 34 are configured to host data 35 about the courses offered by the service provider (e.g. the course frameworks, educational materials to be consumed by the users 14, records of assessments done by users 14, etc.).

The data storage devices 34 may also store authorization criteria that define what actions may be taken by the users 12, 14. In some embodiments, the authorization criteria may include at least one security profile associated with at least one role. For example, one role could be defined for users who are primarily responsible for developing an educational course, teaching it, and assessing work product from other users for that course. Users with such a role may have a security profile that allows them to configure various components of the course, post assignments, add assessments, evaluate performance, and so on.

In some embodiments, some of the authorization criteria may be defined by specific users 40 who may or may not be part of the educational community 16. For example, administrator users 40 may be permitted to administer and/or define global configuration profiles for the system 10, define roles within the system 10, set security profiles associated with the roles, and assign the roles to particular users 12, 14 in the system 10. In some cases, the users 40 may use another computing device (e.g. a desktop computer 42) to accomplish these tasks.

The data storage devices 34 may also be configured to store other information, such as personal information about the users 12, 14 of the system 10, information about which courses the users 14 are enrolled in, roles to which the users 12, 14 are assigned, particular interests of the users 12, 14 and so on.

The servers 32 and data storage devices 34 may also provide other electronic learning management tools (e.g. allowing users to add and drop courses, communicate with other users using chat software, etc.), and/or may be in communication with one or more other vendors that provide the tools.

In some embodiments, the system 10 may also have one or more backup servers 31 that may duplicate some or all of the data 35 stored on the data storage devices 34. The backup servers 31 may be desirable for disaster recovery (e.g. to prevent undesired data loss in the event of an event such as a fire, flooding, or theft). In some embodiments, the backup servers 31 may be directly connected to the educational service provider 30 but located within the system 10 at a different physical location.

In some embodiments, the education system 10 offers various learning tools to facilitate the eLearning experience. For example, tools available to an instructor of a course may include a “Course Builder” tool to assist the instructor in preparing the course, a virtual “Seating Chart” tool to track the participation and “attendance” of each learner in the course, a “Manage Dates” tool help the instructor organize and keep on top of various deadlines, a “Course Calendar” tool for informing the learners in the course of upcoming topics and events, “Survey” tools to solicit feedback from the learners in the course.

Similarly, the learners may have access to various tools. For example, some of the tools listed above could also be used by the learners. The learners may also be presented with a “Drop Box” tool whereby the learners may submit assignments and other assessment material.

It should be noted that the tools listed herein are for exemplary purposes only and are not meant to be limiting. In particular, there may be other learning tools available in some other embodiments.

While having many learning tools can facilitate a successful eLearning experience, they can also increase the complexity of the eLearning system (e.g. system 10). As a result of this complexity, some of the learning tools may be underutilized. For example, the students and/or instructors may not be aware of, or forget about, the availability of some learning tools.

Embodiments described herein generally relate to the monitoring of various system data of the eLearning system 10 to obtain information about user activities (e.g. actions of the learners or instructors), and based on the information obtained, provide suggestions or recommendations about particular learning tools that may improve the users' learning experiences.

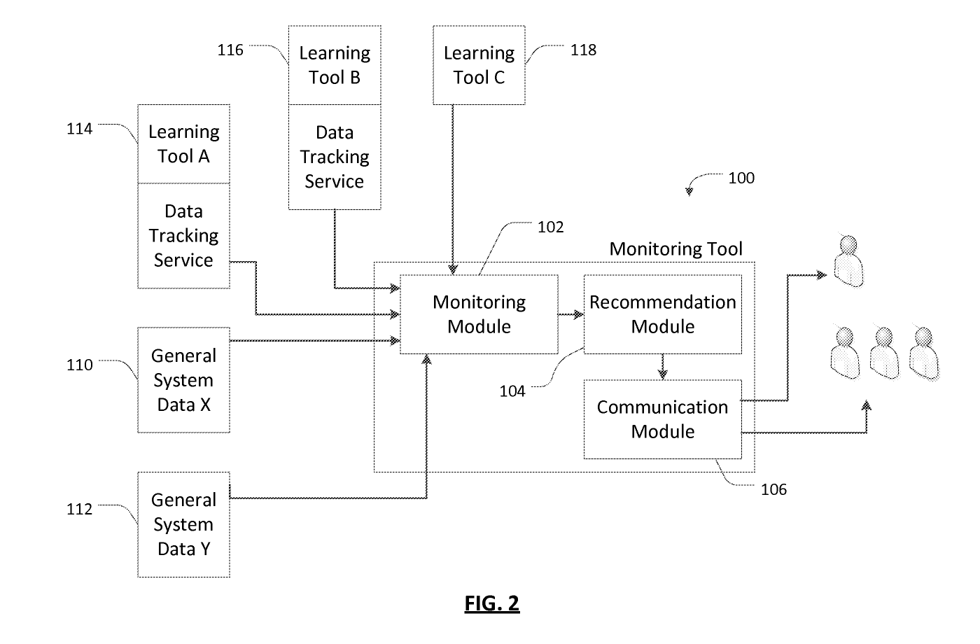

Referring now to FIG. 2, illustrated therein a schematic diagram of some of the modules of a monitoring tool 100 that may be implemented in the eLearning system 10 according to some embodiments. In particular, the monitoring tool 100 may be implemented by configuring and/or adapting one or more of the processors in the servers 32 to provide the illustrated modules.

For example, the monitoring tool 100 may include a monitoring module 102, a recommendation module 104 and a communication module 106.

The monitoring module 102 is adapted to monitor various system data associated with the eLearning system 10. The system data may include tool data associated with various components of the system 10. For example, the system data may include learner login information associated with one or more learners to determine the frequency of each learner's logins into the system 10. In another example, the system data may determine whether a particular system setting has been activated. In another example, the system data may include whether an account identifier has external contact information for notifications associated therewith (e.g. an external email account, a mobile telephone number, and so on). As shown, the monitoring module 102 is monitoring general system data X and Y, indicated by reference numerals 110 and 112 respectively.

In some embodiments, the system data may also include tool data associated with one of the learning tools. For instance, the tool data may include utilization data indicative of the utilization of a particular tool by a particular user, or more generally by a group of users. The tool data may also include information about whether one or more specific aspects of a given tool have been utilized. That is, the tool data may include information about whether all the use cases of the tool are utilized.

As shown, the monitoring module 102 is also monitoring Learning Tools A, B, and C, indicated generally by reference numerals 114, 116 and 118 respectively.

In some embodiments, one or more of the Learning Tools A, B or C may include integrated data tracking services that track various aspects of that tool. For example, the data tracking service for a tool may be built into the tool and may gather tool data on various aspects of that specific tool. The tool data obtained by the tracking service could then be offered to interested applications. In such cases, the monitoring module 102 may request the tool data at particular time periods (e.g. defined periods, such as daily, weekly, monthly, per semester, etc. or at other time periods that are based on dynamic events, such as a user request). The data tracking service for the tool may then respond to the request by providing the tool data to the monitoring module 102. In some cases, it may be possible for the monitoring module 102 to subscribe to the data tracking service such that the tool data is provided to the monitoring tool 102 at regular intervals without requiring requests from the monitoring module 102.

In some embodiments, the system data X or Y may also offer similar internal data tracking services as described above.

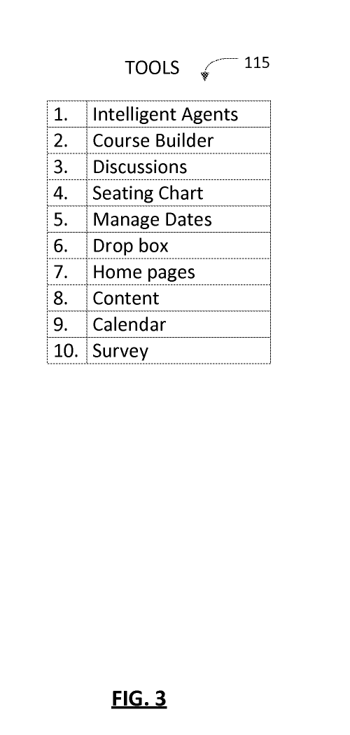

As described above, the monitoring module 102 obtains system data from various components of the system 10. For example, the system data associated with exemplary learning tools 115 shown in FIG. 3 may be monitored by the monitoring module 102. This system data is generally indicative of behavior of one or more users of the learning environment. The obtained system data is then provided to the recommendation module 104 shown in FIG. 2. The recommendation module 104 uses the system data to determine whether there are any undesirable behaviors associated with one of the components of the system by determining whether the system data for a given component meets one or more defined thresholds.

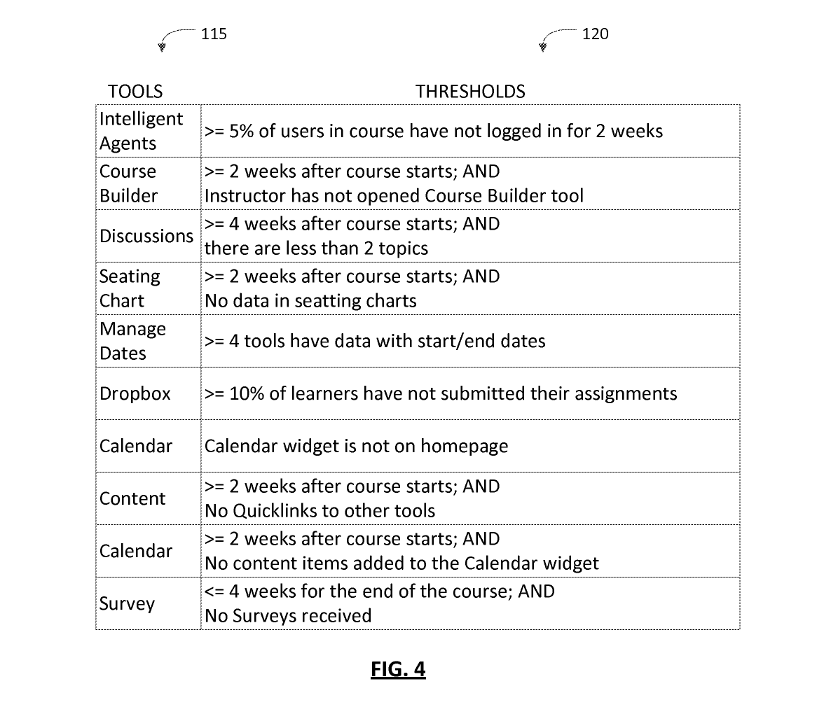

For instance, illustrated in FIG. 4 are some exemplary thresholds 120 for system data related to various exemplary learning tools 115.

In some embodiments, the monitoring tool 100 could analyze thresholds using plug-in applications specific to one or more other learning tools 115. Use of plug-in applications to monitor the learning tools 115 promotes decoupling between the learning tools 115 and the monitoring tool 100. Generally, decoupling reduces risk of a malfunction when changes are made in one or all of the software services that need to communicate with each other. Furthermore, decoupling promotes extensibility so that new component services can be brought online with minimal changes to the existing component services. Each of the thresholds 120 is indicative of undesirable behavior associated with that particular learning tool 115. When one of the thresholds is met, the recommendation module 104 can determine at least one remedial action associated with that threshold which may be engaged to address the undesirable behavior.

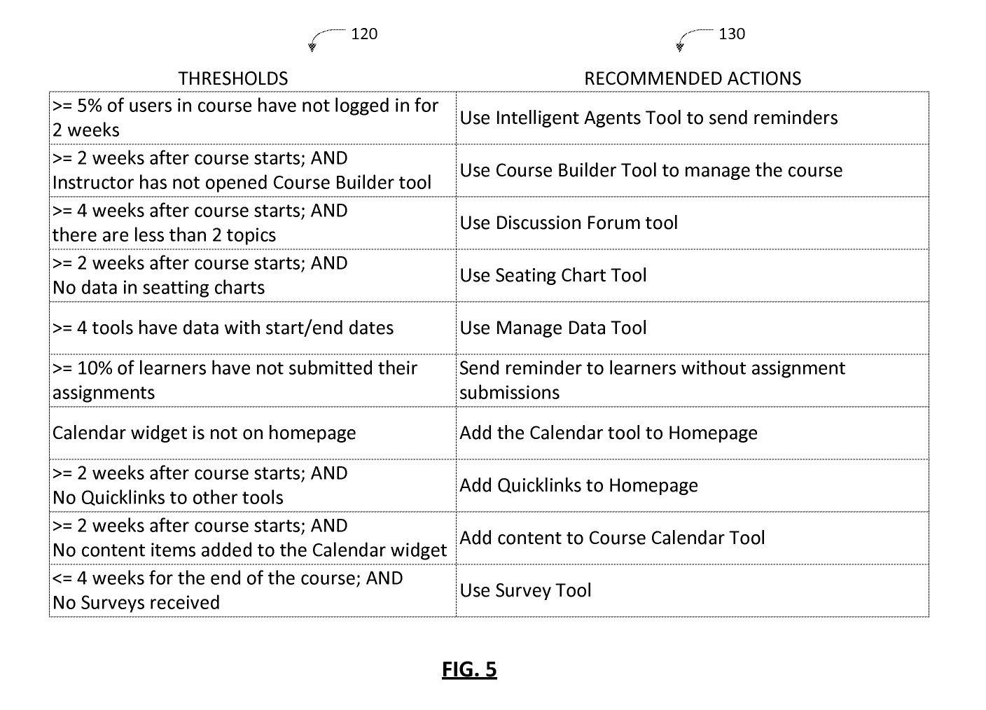

For example, referring now to FIG. 5, illustrated therein are exemplary recommended remedial actions 130 associated with the thresholds 120 for the learning tools 115.

In some embodiments, more than one of the defined thresholds 115 may be met in particular cases. In such cases, the recommendation module 104 may determine a priority value indicative of the importance of addressing the undesirable behavior associated with those thresholds that are being met.

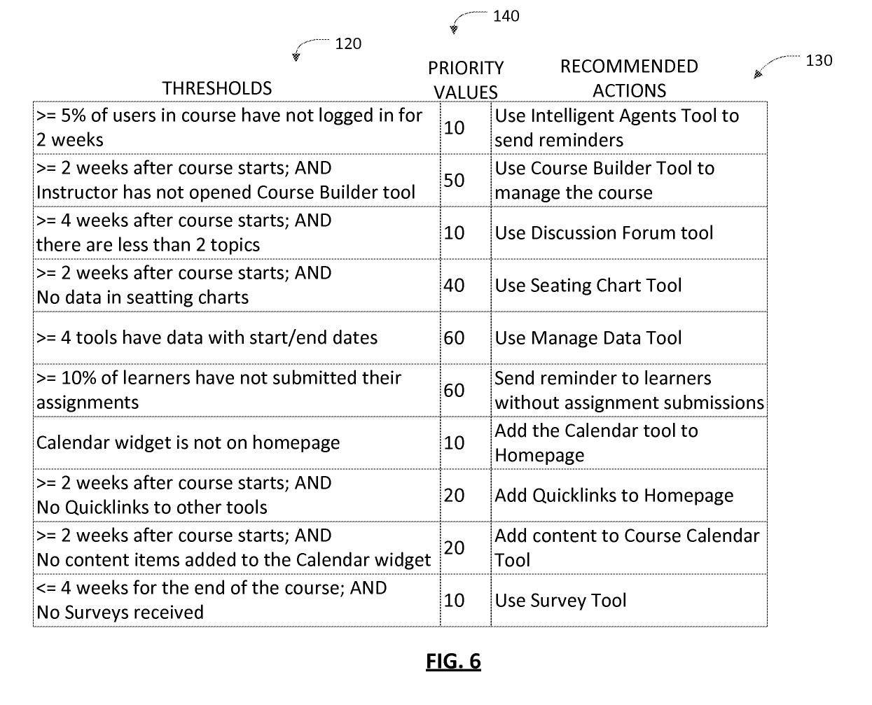

For example, referring now to FIG. 6, illustrated therein is an condition-action matrix including exemplary priority values 140 associated with various recommended actions 130 for addressing the undesirable behavior associated with the thresholds 120. In some embodiments, the priority values associated with each of the recommended actions 130 and learning tools 115 may be pre-defined. In other embodiments, the priority values may be determined or adjusted dynamically based on system heuristics.

In some embodiments, the priority values may be determined or adjusted based on user input. For example, an educational expert may determine the relative importance of each recommended action and/or threshold, for example based on empirical data, to assign the priority values.

Based on the priority values associated with the thresholds 120 and the learning tools 115, the recommendation module 104 may select at least one of those thresholds 120 to address based upon the priority values 140 associated therewith. In the example as shown in FIG. 6, lower number values indicate higher priority. In some embodiments, the priority may be determined at least partially based upon the system data. For example, if the threshold value is exceeded by a wide margin, the priority value associated with that threshold may be increased.

Once the recommendation module 104 determines which thresholds 120 to act upon, the recommendation module 104 can then determine the remedial action 130 associated with the selected threshold 120. This remedial action 130 may be determined based on instructional design paradigms or a predefined work flow.

In some embodiments, all possible remedial actions may be predefined. The recommendation module 104 may then select one or more remedial actions from those predefined remedial actions based upon the priority values associated with the tool, threshold, and/or remedial action.

After determining which of the issues to address, the recommendation module 104 may determine which of the users of the system to communicate the associated remedial action(s) to. In particular, in some embodiments the users may be determined based on the system data obtained by the monitoring module 102. The communication could also be directed to a specific single user (e.g. a student or an instructor) or a group of users (e.g. a class, a lab group), and so on.

Generally, the recommendation module 104 provides remedial action(s) 130 associated with the threshold(s) 120 to the communication module 106. The communication module 106 in turn then sends information about the remedial actions 130 to the users selected to receive the communication messages.

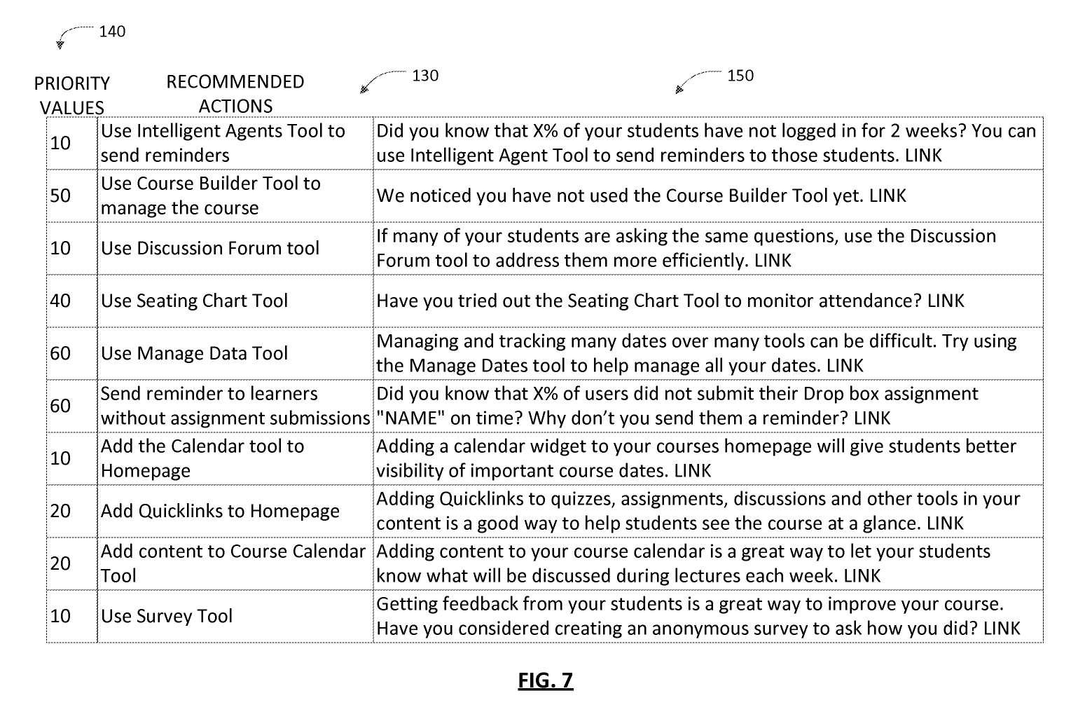

Referring now to FIG. 7, illustrated therein are exemplary information messages 150 associated with the thresholds 120 that may be sent to various users. The information may be communicated using various electronic communication methods such as email, text message, instant messaging, and so on.

Generally, prioritizing the importance of undesirable behavior can reduce the number of communications provided to the user and allow the user to focus on the more important undesirable behaviors. This may reduce overwhelming the user with multiple communication messages. In particular, in some embodiments, only one threshold to communicate may be selected. Moreover, in some embodiments, no further thresholds may be selected until the instructor acts on the selected threshold.

While it is possible to provide a version of the monitoring tool 100 in each of the tools, there may certain advantages to having the monitoring tool 100 as a separate component from a system architecture perspective. For example, this architecture may allow the monitoring tool 100 to be generally independent from the learning tools 114, 116, and 118. As such, if a new learning tool is added, or an existing learning tool 114, 116, and 118 is removed or updated, the adaptations required for the monitoring tool 100 would tend to be fairly minimal. Furthermore, by gathering system data from various components at a centralized location, the monitoring tool 100 may make more informed decisions as to the priority of issues to address.

In some embodiments, the monitoring tool 100 may run as a service. In some cases, the service may only run at particular intervals (e.g. daily, weekly, monthly) so as to reduce demand for system resources.

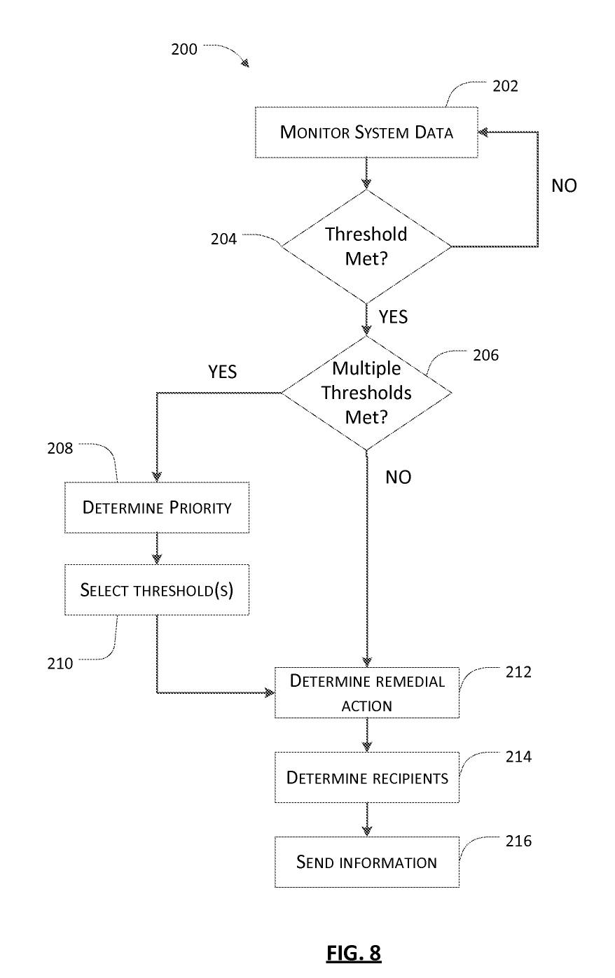

Referring now to FIG. 8, illustrated therein is a computer-implemented eLearning method 200 according to one embodiment. In some examples, one or more components of the system 10 (e.g. one or more processors on the server 32) may be adapted to execute the eLearning method 200.

At step 202, the system data associated with one or more components of a learning environment (e.g. the online learning environment provided by the system 10) is monitored. The system data may be indicative of behavior of one or more users of the learning environment. For example, the system data may include data about learning tools or other data about various aspects of the system. The learning tools may be the learning tools 115 shown in FIG. 3, and a monitoring module such as the monitoring module 102 may be used to monitor the system data.

At step 204, a determination is made as to whether the system data for a given component meets or exceeds one or more defined thresholds. Each threshold being indicative of undesirable behavior associated with that particular component. In some cases, the thresholds may be predefined or may be defined and/or adjusted dynamically based on the system data (e.g. the monitored system data from step 202). The thresholds may be the thresholds 120 shown in FIG. 4. If at least one of the thresholds is met, the method 200 proceeds to step 206. Alternatively, if no threshold is met then the method 200 returns to step 202.

At step 206, a determination is made as to whether multiple thresholds have been met. If it is determined that multiple thresholds have been met, the method 200 proceeds to step 208. Alternatively, the method 200 continues to step 212.

At step 208, a priority value indicative of an importance of addressing the undesirable behavior associated with the met thresholds is determined. The priority values may be the priority values 140 shown in FIG. 6 for example. In some embodiments, the priority values may be pre-defined. In other embodiments, the priority values may be dynamically defined and/or adjusted based on system data.

At step 210, at least one of specific thresholds to address is selected based on the priority values established at step 208. The method 200 then proceeds to step 212.

At step 212, one or more remedial actions associated with the threshold(s) are determined. The remedial action may be employed to address the undesirable behavior associated with the threshold(s), and in some embodiments could be the remedial actions 130 shown in FIG. 5. In some cases, the remedial actions may be determined based on instructional design paradigms or a predefined work flow.

At step 214, the intended users for the remedial actions are determined.

At step 216, the method 200 communicates information about the at least one remedial action to at least one user determined in step 214. The information, for example, may be the information messages 150 shown in FIG. 7. Based on the communicated information, the undesired user behaviors can then be corrected.

While the above description provides examples of one or more apparatus, methods, or systems, it will be appreciated that other apparatus, methods, or systems may be within the scope of the present description as interpreted by one of skill in the art.

1. A computer-implemented eLearning method comprising:
monitoring system data about one or more components of an online learning environment, the system data being indicative of behavior of one or more users of the learning environment;
determining whether the system data for a given component meets one or more defined thresholds, each threshold being indicative of undesirable behavior associated with that component;
if one of the given thresholds is met, determining at least one remedial action associated with that threshold which may be employed to address the undesirable behavior; and
communicating information about the at least one remedial action to at least one user.

2. The method of claim 1, wherein when more than one defined thresholds are met, the method further comprises:
determining a priority value indicative of importance of addressing the undesirable behavior associated with those thresholds;
selecting at least one of those thresholds to address based on the priority value; and
determining the remedial action associated with the selected threshold.

3. The method of claim 2, wherein the remedial actions and priority values associated with each threshold are determined based upon a predefined condition-action matrix.

4. The method of claim 1, wherein the at least one remedial action that may be employed when the threshold is met is determined based upon instructional design.

5. The method of claim 1, wherein the at least one remedial action that may be employed when the threshold is met is determined based upon at least one predefined workflow.

6. The method of claim 1, wherein the system data about one or more components includes utilization data for those components.

7. The method of claim 6, wherein the utilization data includes user-account information indicative of one or more users that have or have not utilized one of the components in a given period of time.

8. The method of claim 7, wherein the one or more components includes one or more learning tools, and the system data includes tool data indicative of utilization of one or more aspects of those tools

9. The method of claim 8, wherein one of the remedial actions includes sending a targeted notification message to the one or more users that have not utilized one of the components.

10. The method of claim 1, wherein one of the remedial actions includes sending a plurality of notification messages to a plurality of users associated with a system component.

11. An online learning system comprising a processor adapted to provide:
a monitoring module, the monitoring module operable to monitor system data about one or more components of the online learning environment, the system data being indicative of behavior of one or more users of the learning environment;
a recommendation module, the recommendation module operable to
i. determine whether the system data for a given component meets one or more defined thresholds, each threshold being indicative of undesirable behavior associated with that component, and
ii. if one of the given thresholds is met, determine at least one remedial action associated with that threshold which may be employed to address the undesirable behavior; and
a communication module, the communication module operable to communicate information about the at least one remedial action to at least one user.

12. The system of claim 11, wherein when more than one defined thresholds are met the recommendation module is further operable to:
determine a priority value indicative of importance of addressing the undesirable behavior associated with those thresholds;
select at least one of those thresholds to address based on the priority value; and
determine the remedial action associated with the selected threshold.

13. The system of claim 12, wherein the remedial actions and priority values associated with each threshold are determined based upon a predefined condition-action matrix.

14. The system of claim 11, wherein the at least one remedial action that may be employed when the threshold is met is determined based upon instructional design.

15. The system of claim 11, wherein the at least one remedial action that may be employed when the threshold is met is determined based upon at least one predefined workflow.

16. The system of claim 11, wherein the system data about one or more components includes utilization data for those components.

17. The system of claim 16, wherein the one or more components includes one or more learning tools, and the system data include tool data indicative of utilization of one or more aspects of those tools

18. The system of claim 16, wherein the utilization data includes user-account information indicative of one or more users that have or have not utilized one of the components in a given period of time.

19. The system of claim 18, wherein one of the remedial actions includes sending a targeted notification message to the one or more users that have not utilized one of the components.

20. The system of claim 11, wherein one of the remedial actions includes sending a plurality of notification messages to a plurality of users associated with a system component.
